(19) United States
(12) Patent Application Publication
(10) Pub. No.: US 2020/0092414 A1
(43) Pub. Date: Mar. 19, 2020

(54) MANAGEMENT SERVER, COMMUNICATION METHOD, AND NON-TRANSITORY COMPUTER READABLE MEDIUM

(71) Applicant: NEC CORPORATION, Tokyo (JP)

(72) Inventor: Shota MORISHITA, Tokyo (JP)

(73) Assignee: NEC CORPORATION, Tokyo (JP)

(21) Appl. No.: 16/493,833

(22) PCT Filed: Feb. 28, 2018
(86) PCT No.: PCT/JP2018/007436

§ 371 Date: Sep. 13, 2019

(30) Foreign Application Priority Data
Mar. 15, 2017 (JP) 2017-050265

(51) Int. Cl. H04M 3/42; G06F 17/27; G10L 15/197; G10L 15/22

(52) U.S. Cl. CPC H04M 3/42; G06F 17/2785; G10L 15/197; G10L 15/22; H04M 2203/558; H04M 2201/39; H04M 2242/08; H04M 2203/2011; H04M 2201/60

(57) ABSTRACT

A management server includes a call detection unit that detects a call from a first communication terminal to a second communication terminal, an information acquisition unit that acquires, when the call detection unit detects the call, essential information associated with the first communication terminal, an inquiry unit that transmits inquiry information to the first communication terminal to inquire about an information transmission means to the second communication terminal, and a transmission unit that transmits the essential information to the second communication terminal using an information transmission means indicated by response information transmitted from the first communication terminal in response to the inquiry information.

### TECHNICAL FIELD

The present disclosure relates to a management server, a communication method, and a program.

### BACKGROUND ART

For recent communication, various information transmission means using voice, such as a phone call, and text, such as an electronic mail or a Fax, are used. In these information transmission means, there may be a case where a certain information transmission means can be inconvenient for a caller or a receiver.

In addition, in a case of emergency communication, such as an accident or rescue, a caller who reports an emergency can be too panicked to notify the contact destination of necessary information.

Hence, a technique in which input text information is converted into synthesized voice to transmit a contact destination (for example, see Patent Literature 1) has been studied. Further, Patent Literature 1 discloses that text information using fixed phrases based on input information is transmitted to a contact destination.

### CITATION LIST

### Patent Literature

Patent Literature 1: Japanese Unexamined Patent Application Publication No. 2015-115740

### SUMMARY OF INVENTION

### Technical Problem

With the technique disclosed in Patent Literature 1, there is a problem that a caller cannot select a desired information transmission means. Further, there is a problem that a caller has to input text into fixed phrases, which is time consuming.

A purpose of the present disclosure is to provide a management server, a communication method, and a program that solve the above problem.

### Solution to Problem

A management server according to the present disclosure includes:
a call detection unit that detects a call from a first communication terminal to a second communication terminal;
an information acquisition unit that acquires, when the call detection unit detects the call, essential information associated with the first communication terminal;
an inquiry unit that transmits, to the first communication terminal, inquiry information for inquiring about an information transmission means to the second communication terminal; and
a transmission unit that transmits the essential information to the second communication terminal using an information transmission means indicated by response information transmitted from the first communication terminal in response to the inquiry information.

A communication method according to the present disclosure includes:
detecting a call from a first communication terminal to a second communication terminal;
acquiring, when the call is detected, essential information associated with the first communication terminal;
transmitting, to the first communication terminal, inquiry information for inquiring about an information transmission means to the second communication terminal; and
transmitting the essential information to the second communication terminal using an information transmission means indicated by response information transmitted from the first communication terminal in response to the inquiry information.

A program according to the present disclosure causes a computer to execute:
a step of detecting a call from a first communication terminal to a second communication terminal;
a step of acquiring, when the call is detected, essential information associated with the first communication terminal;
a step of transmitting, to the first communication terminal, inquiry information for inquiring about an information transmission means to the second communication terminal; and
a step of transmitting the essential information to the second communication terminal using an information transmission means indicated by response information transmitted from the first communication terminal in response to the inquiry information.

### Advantageous Effects of Invention

As described above, with the present disclosure, it is possible to easily convey necessary information by a desired information transmission means.

### BRIEF DESCRIPTION OF DRAWINGS

FIG. 1 is a diagram showing a management server according to a first example embodiment of the present disclosure.

FIG. 2 is a flowchart for explaining an example of a communication method for the management server shown in FIG. 1.

FIG. 3 is a diagram showing a management server according to a second example embodiment of the present disclosure.

FIG. 4 is a diagram showing an example of an internal configuration of the management server shown in FIG. 3.

FIG. 5 is a diagram showing an example of essential information stored in a database shown in FIG. 4.

FIG. 6 is a diagram for explaining an example of a procedure in a communication system shown in FIG. 3.

FIG. 7 is a diagram showing a management server according to a third example embodiment of the present disclosure.

FIG. 8 is a diagram showing an example of an internal configuration of the management server shown in FIG. 7.

FIG. 9 is a diagram showing an example of essential information stored in a database shown in FIG. 8.

FIG. 10 is a diagram showing an example of association of input information with prediction sentences stored in the database shown in FIG. 8.

FIG. 11 is a diagram for explaining an example of a procedure in a communication system shown in FIG. 7.

### DESCRIPTION OF EMBODIMENTS

Hereinafter, example embodiments of the present disclosure are described with reference to the drawings.

### First Example Embodiment

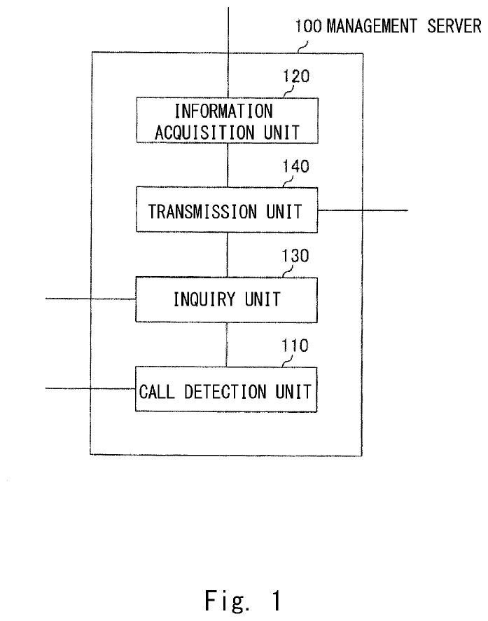

FIG. 1 is a diagram showing a management server according to a first example embodiment of the present disclosure.

As shown in FIG. 1, a management server 100 according to the present example embodiment includes a call detection unit 110, an information acquisition unit 120, an inquiry unit 130, and a transmission unit 140. Note that, in regard to the constituent elements included in the management server 100 according to the present disclosure, FIG. 1 shows, as an example, the main constituent elements relating to the present example embodiment.

The call detection unit 110 detects a call from a communication terminal (a first communication terminal) to another communication terminal (a second communication terminal).

When the call detection unit 110 detects the call, the information acquisition unit 120 acquires essential information associated with a source communication terminal.

The inquiry unit 130 transmits inquiry information to the source communication terminal to inquire about an information transmission means to a destination communication terminal.

The transmission unit 140 transmits the essential information to the destination communication terminal using the information transmission means indicated by response information transmitted from the source communication terminal in response to the inquiry information.

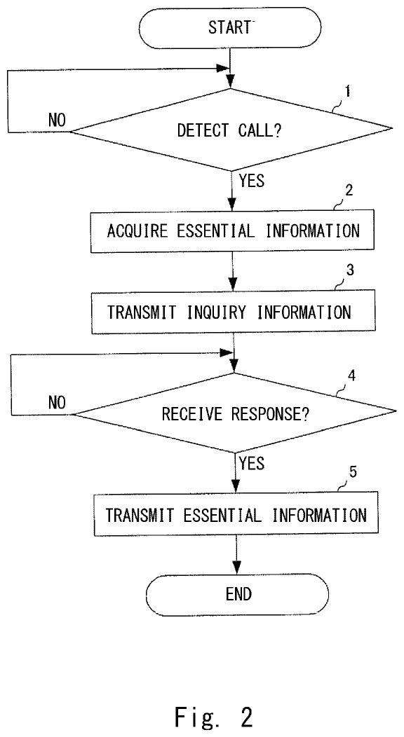

In the following, a communication method for the management server 100 shown in FIG. 1 is described. FIG. 2 is a flowchart for explaining an example of the communication method for the management server 100 shown in FIG. 1.

First, in step 1, the call detection unit 110 detects a call from a communication terminal (hereinafter, referred to as a source communication terminal) to another communication terminal (hereinafter, referred to as a destination communication terminal). In step 2, the information acquisition unit 120 acquires essential information associated with the source communication terminal. Then, in step 3, the inquiry unit 130 transmits inquiry information to the source communication terminal to inquire about an information transmission means to the destination communication terminal. Then, in step 4, the inquiry unit 130 receives a response to the transmitted inquiry information. Then, in step 5, the transmission unit 140 transmits the essential information to the destination communication terminal using the information transmission means indicated by response information transmitted from the source communication terminal in response to the inquiry information.

In this manner, the management server 100 inquires of the source communication terminal about an information transmission means, and transmits the essential information about the source communication terminal to the destination communication terminal by the information transmission means indicated by the response information from the source communication terminal.

Thus, it is possible to easily convey necessary information with a desired information transmission means.

### Second Example Embodiment

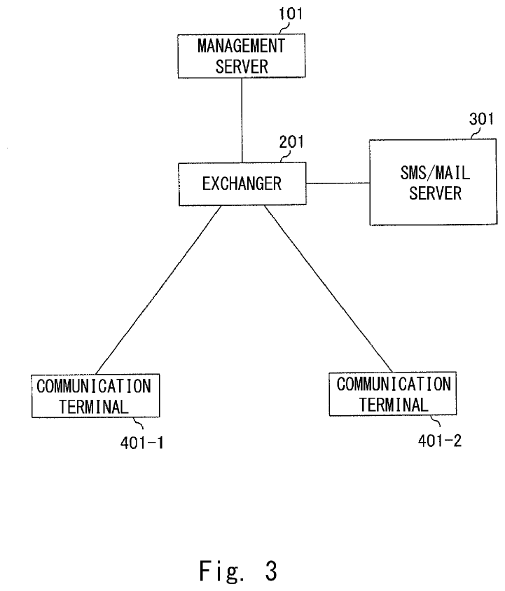

FIG. 3 is a diagram showing a management server according to a second example embodiment of the present disclosure.

As shown in FIG. 3, a communication system in which a management server 101 according to the present example embodiment is provided includes the management server 101, an exchanger 201, an SMS/mail server 301, and communication terminals 401-1 and 401-2. The management server 101 is connected with the exchanger 201. The exchanger 201 is connected with the SMS/mail server 301 and the communication terminals 401-1 and 401-2. Note that, the management server 101 may be connected with the SMS/mail server 301.

The communication terminals 401-1 and 401-2 are communication devices that transmit and receive calls and electronic mails. In addition, the communication terminals 401-1 and 401-2 may be fixed devices or mobile portable devices. Note that, FIG. 3 shows, as an example, two communication terminals for the sake of the following explanation, but the number of communication terminals is not limited.

The exchanger 201 is a common telephone exchanger that switches lines. The SMS/mail server 301 is a server device used to transmit and receive messages using a common Short Message Service (SMS) or electronic mails.

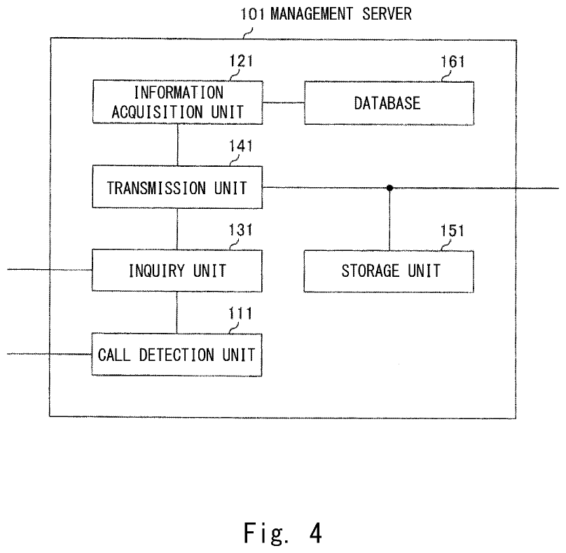

FIG. 4 is a diagram showing an example of an internal configuration of the management server 101 shown in FIG. 3. As shown in FIG. 4, the management server 101 shown in FIG. 3 includes a call detection unit 111, an information acquisition unit 121, an inquiry unit 131, a transmission unit 141, a storage unit 151, and a database 161. Note that, in constituent elements included in the management server 101 shown in FIG. 3, FIG. 4 shows, as an example, main constituent elements relating to the present example embodiment.

The call detection unit 111 detects a call from the communication terminal 401-1 to the communication terminal 401-2 through the exchanger 201. The call detection unit 111 further detects a call from the communication terminal 401-2 to the communication terminal 401-1 through the exchanger 201. The following is to be described on the assumption that a call is made from the communication terminal 401-1 to the communication terminal 401-2 as an example.

The database 161 stores essential information about the users of the communication terminals 401-1 and 401-2. Note that, the database 161 may be provided outside the management server 101.

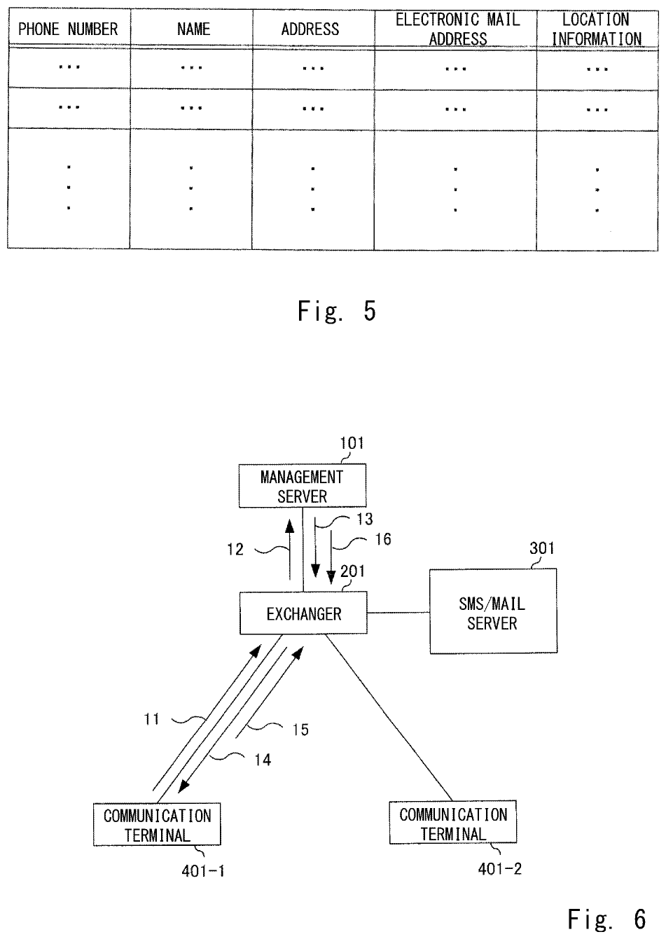

FIG. 5 is a diagram showing an example of essential information stored in the database 161 shown in FIG. 4. As shown in FIG. 5, the database 161 shown in FIG. 4 stores essential information for each user. The essential information includes a phone number, a name, an address, an electronic mail address, personal identification information (identification information for identifying a person, such as an identification (ID)), and location information. Other types of information specific to a user may be stored. The essential information is set in advance using the communication terminals 401-1 and 401-2 and is changeable at any time. The location information may be periodically acquired by a Global Positioning System (GPS) function included in each of the communication terminals 401-1 and 401-2 or by a radio base station connected with the communication terminals 401-1 and 401-2, and the method for acquiring the location information is not limited.

When the call detection unit 111 detects a call, the information acquisition unit 121 acquires the essential information associated with the communication terminal 401-1 from the database 161. The information acquisition unit 121 may acquire all pieces of the essential information stored in the database 161 or at least one piece of the essential information. The information acquisition unit 121 uses the phone number of the communication terminal 401-1 detected by the call detection unit 111 as a search key to acquire the essential information about the communication terminal 401-1 associated with the phone number from the database 161.

The inquiry unit 131 transmits inquiry information to the communication terminal 401-1 to inquire about an information transmission means to the communication terminal 401-2. Here, the inquiry unit 131 transmits inquiry information for inquiring which of, for example, a text communication, such as a message using an SMS, an electronic mail, or a Fax, and a voice communication, such as a call, is to be selected as the information transmission means.

The transmission unit 141 transmits the essential information to the communication terminal 401-2 using the information transmission means indicated by response information transmitted from the communication terminal 401-1 in response to the inquiry information. The transmission unit 141 further transmits, to the communication terminal 401-2, input information transmitted from the communication terminal 401-1 using the information transmission means. Specifically, the transmission unit 141 instructs the exchanger 201 or the SMS/mail server 301 to transmit, to the communication terminal 401-2, the input information transmitted from the communication terminal 401-1 using the information transmission means. This input information is the text of a chat input using an application run on the communication terminal 401-1, of an SMS message, or of an electronic mail message (its body), a speech voice, or the like.

The storage unit 151 stores information transmitted to the communication terminal 401-2. This information is a voice signal when the information transmission means from the communication terminal 401-1 to the communication terminal 401-2 is voice, or text information when the information transmission means from the communication terminal 401-1 to the communication terminal 401-2 is text. The information stored in the storage unit 151 may be readable by certain external devices, such as the communication terminals 402-1 and 402-2. The information stored in the storage unit 151 may be separately transmitted to the communication terminals 401-1 and 401-2 with a message using an SMS or an electronic mail.

In the following, a communication method for the communication system shown in FIG. 3 is described. FIG. 6 is a diagram for explaining an example of a procedure in the communication system shown in FIG. 3.

First, in step 11, the communication terminal 401-1 makes a call to the communication terminal 401-2. In step 12, the exchanger 201 notifies the management server 101 of the call. When the communication terminal 401-1 makes this call, the communication terminal 401-1 may perform, based on an external operation of the user, authentication of the user using the system, such as inputting a personal identification number (PIN). In the management server 101, when the call detection unit 111 detects the call from the communication terminal 401-1 to the communication terminal 401-2, the information acquisition unit 121 acquires the essential information associated with the communication terminal 401-1 from the database 161. At this time, the information acquisition unit 121 acquires the name, the address, the electronic mail address, the personal identification information, the location information, and the like associated with the phone number of the communication terminal 401-1 from the database 161. In steps 13 and 14, the inquiry unit 131 transmits inquiry information to the communication terminal 401-1 through the exchanger 201 to inquire about an information transmission means to the communication terminal 401-2. This inquiry information is for inquiring which of a text communication or a voice communication is to be selected as the information transmission means to the communication terminal 401-2. Alternatively, this inquiry information may be for inquiring about whether to select transmitting only the essential information.

The communication terminal 401-1 outputs the inquiry information as a guidance. For example, the communication terminal 401-1 may display or output by voice a message “Press 1 to synthesize voice or press 2 to convert the message into text data”. Alternatively, the communication terminal 401-1 may, for example, display or output by voice a message “Input your PIN and press 1 to notify the contact person of the essential information”.

Then, in step 15, the communication terminal 401-1 transmits, to the management server 101 thorough the exchanger 201, the response information input based on the user's operation in response to the output inquiry information. In step 16, the management server 101 outputs an instruction to the exchanger 201 to receive the call from the communication terminal 401-1 to the communication terminal 401-2.

When the response information indicates a voice communication, the transmission unit 141 instructs the exchanger 201 to transmit the essential information and the input information input and transmitted by the communication terminal 401-1 thereafter to the communication terminal 401-2 by voice obtained by voice synthesis or the like. On the other hand, when the response information indicates a text communication, the transmission unit 141 instructs the SMS/mail server 301 to transmit the essential information and the input information input and transmitted by the communication terminal 401-1 thereafter to the communication terminal 401-2 by text data. At this time, the conversion from the voice data to the text data may be performed by the transmission unit 141. The storage unit 151 stores the communication between the communication terminal 401-1 and the communication terminal 401-2.

In the above example embodiment, a usage example in which so-called a smart phone is used as each of the communication terminals 401-1 and 401-2 is described. When the communication terminals 401-1 and 401-2 are so-called feature phones, the usage method is slightly different. However, a usage example of a feature phone can be utilized by a device such as a smart phone.

When the communication terminal 401-1 that is a feature phone makes a phone call, the management server 101 detects the call and causes the communication terminal 401-2 to receive the call through the exchanger 201. After the communication terminal 401-2 receives the call, the management server 101 ends the call through the exchanger 201 when the communication terminal 401-1 receives an external operation (for example, a button operation or the like). Then, the management server 101 instructs the SMS/mail server 301 to transmit, to the communication terminal 401-1, an SMS/electronic mail or the like that can be processed by the communication terminal 401-1. This SMS/electronic mail or the like may include Uniform Resource Locator (URL) information for connecting a predetermined website. Then, when the communication terminal 401-1 transmits input information by designating the URL indicated by the URL information included in the SMS/electronic mail or the like transmitted from the SMS/mail server 301, the management server 101 and the SMS/mail server 301 transmit the input information to the communication terminal 401-2.

Then, information input to the communication terminal 401-2 in response to the input information transmitted to the communication terminal 401-2 is transmitted to the communication terminal 401-1 through the management server 101 and the SMS/mail server 301.

By performing this processing, information transmitted and received between the communication terminal 401-1 and the communication terminal 401-2 is displayed, for example, in a conversation style, such as a chat.

In addition, until information is input to the communication terminal 401-1, the communication between the communication terminal 401-1 and the communication terminal 401-2 may be in a standby state without being disconnected. In this case, a message indicating that the communication terminal 401-2 is in the standby state (for example, “Caller is inputting information. Please wait.” as a guidance) may be output by voice during the standby state.

Alternatively, at a timing when inputting information to the communication terminal 401-1, such as chat inputting as described above, is started, the start of inputting may be notified to the management server 101. In this case, the notified management server 101 may make a call from a predetermined phone number (for example, a calling-only number or the like) to the communication terminal 401-2, the communication terminal 401-1 may perform text inputting, and the communication terminal 401-2 may perform voice inputting.

In this manner, the management server 101 transmits the essential information about the source communication terminal and the input information to the destination communication terminal using the information transmission means desired by the source communication terminal. Thus, it is possible to easily convey necessary information by a desired information transmission means.

Specifically, it is possible to transmit information using various information transmission means, such as a call, an electronic mail, or a FAX, at any time and situation.

### Third Example Embodiment

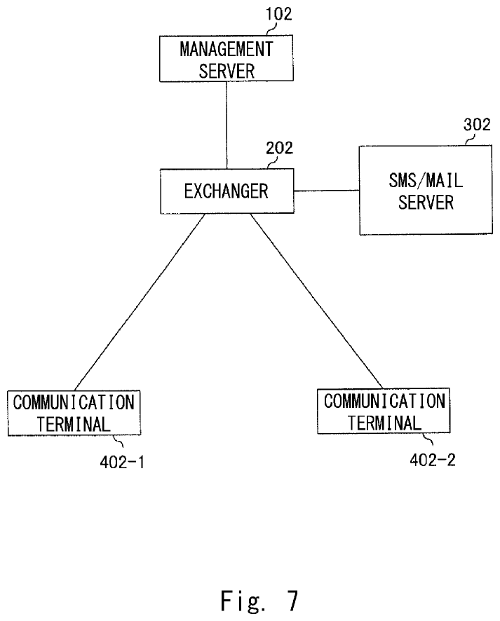

FIG. 7 is a diagrams showing a management server according to a third example embodiment of the present disclosure.

As shown in FIG. 7, a communication system in which a management server 102 according to the present example embodiment is provided includes the management server 102, an exchanger 202, an SMS/mail server 302, and communication terminals 402-1 and 402-2. The management server 102 is connected with the exchanger 202. The exchanger 202 is connected with the SMS/mail server 302 and the communication terminals 402-1 and 402-2. Note that, the management server 102 may be connected with the SMS/mail server 302. The communication terminals 402-1 and 402-2 are communication devices that can transmit and receive calls and electronic mails. In addition, the communication terminals 402-1 and 402-2 may be fixed devices or mobile portable devices. Note that, FIG. 7 shows an example in which the number of communication terminals is two. This configuration is adopted for the sake of the following explanation, but the number of communication terminals is not limited two.

The exchanger 202 is a common telephone exchanger that switches lines. The SMS/mail server 302 is a server device used to transmit and receive massages using a common SMS or electronic mails.

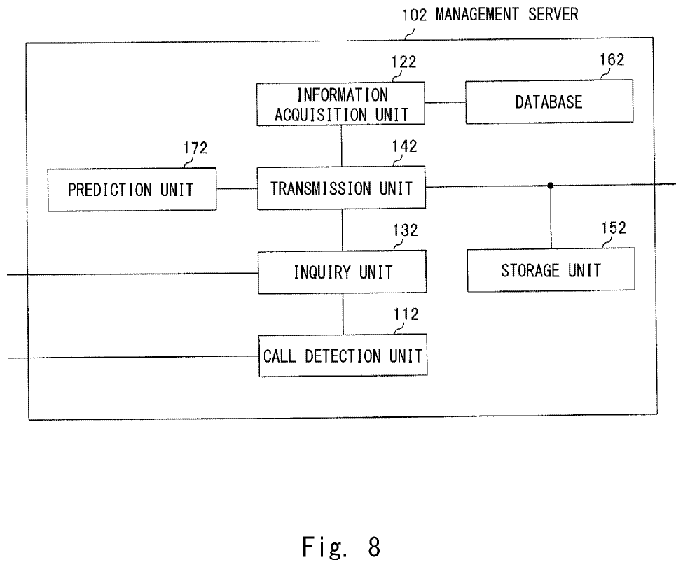

FIG. 8 is a diagram showing an example of an internal configuration of the management server 102 shown in FIG. 7. As shown in FIG. 8, the management server 102 shown in FIG. 7 includes a call detection unit 112, an information acquisition unit 122, an inquiry unit 132, a transmission unit 142, a storage unit 152, a database 162, and a prediction unit 172. Note that, in constituent elements included in the management server 102 shown in FIG. 7, FIG. 8 shows, as an example, main constituent elements relating to the present example embodiment.

The call detection unit 112 detects a call from a communication terminal 402-1 to a communication terminal 402-2 through the exchanger 202. The call detection unit 112 further detects a call from the communication terminal 402-2 to the communication terminal 402-1 through the exchanger 201. The following is to be described on the assumption that a call is made from the communication terminal 402-1 to the communication terminal 402-2 as an example.

The database 162 stores essential information about the users of the communication terminals 402-1 and 402-2. The database 162 further stores input information and prediction sentences which are associated with each other. Note that, the database 162 may be provided outside the management server 102.

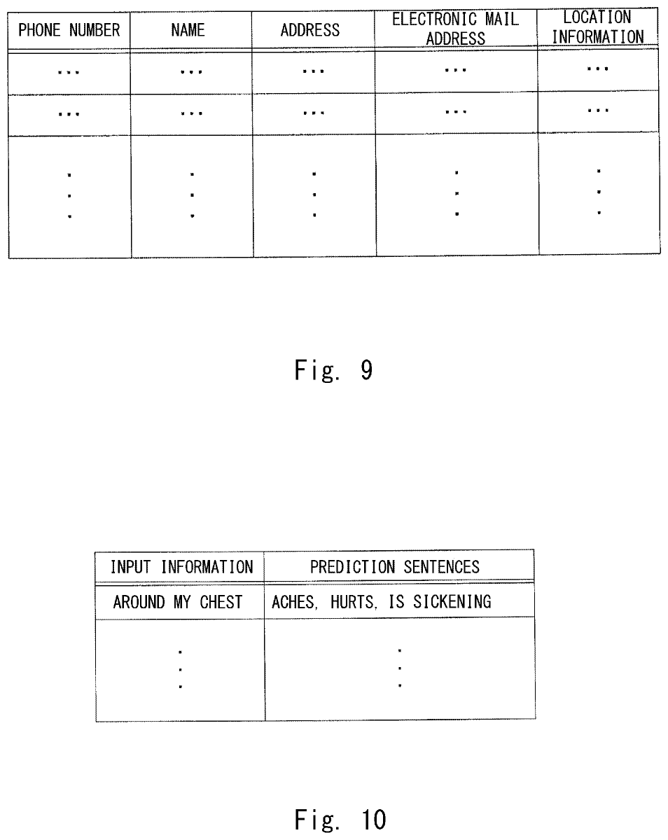

FIG. 9 is a diagram showing an example of essential information stored in the database 162 shown in FIG. 8. As shown in FIG. 9, the database 162 shown in FIG. 8 stores essential information for each user. The essential information includes a phone number, a name, an address, an electronic mail address, personal identification information (identification information such as a uniquely assigned

ID for identifying a person), and location information. Other types of information specific to a user may be stored. The essential information is set in advance using the communication terminals 402-1 and 402-2 and is changeable at any time. The location information may be periodically acquired by a GPS function included in each of the communication terminals 402-1 and 402-2 or acquired by a radio base station connected with the communication terminals 402-1 and 402-2, and the method for acquiring the location information is not limited.

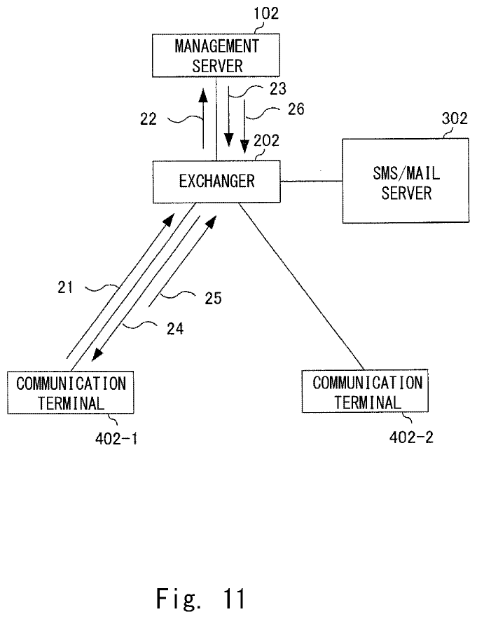

FIG. 10 is a diagram showing an example of association of input information with prediction sentences stored in the database 162 shown in FIG. 8. As shown in FIG. 10, the database 162 shown in FIG. 8 stores input information and prediction sentences which are associated with each other. In the example shown in FIG. 10, input information “around my chest” and prediction sentences “aches”, “hurts”, and “is sickening” are associated with each other and are stored. The prediction unit 172 predicts a sentence using this association. The association may be set from an external device or set/updated as needed based on the content of the communication between communication terminals. In addition, the database 162 may store association of input information with prediction sentences separately from each category.

When the call detection unit 112 detects a call, the information acquisition unit 122 acquires the essential information associated with the communication terminal 402-1 from the database 162. The information acquisition unit 122 may acquire all pieces of the essential information stored in the database 162 or at least one piece of the essential information. The information acquisition unit 122 uses the phone number of the communication terminal 402-1 detected by the call detection unit 112 as a search key to acquire the essential information about the communication terminal 402-1 associated with the phone number from the database 162.

The inquiry unit 132 transmits inquiry information to the communication terminal 402-1 to inquire about an information transmission means to the communication terminal 402-2. Here, the inquiry unit 132 transmits inquiry information for inquiring which of, for example, a text communication, such as a message using an SMS, an electronic mail, or a Fax, and a voice communication, such as a call, is to be selected as the information transmission means.

The prediction unit 172 acquires prediction sentences based on the input information transmitted from the communication terminal 402-1. Specifically, the prediction unit 172 uses the input information transmitted from the communication terminal 402-1 as a search key to acquire stored prediction sentences associated with the input information from the database 162. For example, the database 162 stores the association shown in FIG. 10, and when the input information transmitted from the communication terminal 402-1 is “around my chest”, the prediction unit 172 acquires “aches”, “hurts”, or “is sickening” as the prediction sentences. Alternatively, when the database 162 stores association of input information with prediction sentences separately from each category, the prediction unit 172 may acquire prediction sentences from the association corresponding to a category designated by the communication terminal 402-1. At this time, the communication terminal 402-1 making a call provide a display for the operator of the communication terminal 402-1 to select a category.

The transmission unit 142 transmits the essential information to the communication terminal 402-2 using the information transmission means indicated by response information transmitted from the communication terminal 402-1 in response to the inquiry information. The transmission unit 142 further transmits, to the communication terminal 402-2, the input information transmitted from the communication terminal 402-1 using the information transmission means. Specifically, the transmission unit 142 instructs the exchanger 202 or the SMS/mail server 302 to transmit, to the communication terminal 402-2, the input information transmitted from the communication terminal 401-1 using the information transmission means. This input information is the text of a chat input using an application run on the communication terminal 402-1, of an SMS message, or of an electronic mail message (its body), a speech voice, or the like. The transmission unit 142 further transmits the sentences predicted by the prediction unit 172 to the communication terminal 402-2. At this time, the transmission unit 142 transmits the prediction sentences together with the input information used by the prediction unit 172 to predict the sentences.

The storage unit 152 stores information transmitted to the communication terminal 402-2. This information is a voice signal when the information transmission means from the communication terminal 402-1 to the communication terminal 402-2 is voice, or text information when the information transmission means from the communication terminal 402-1 to the communication terminal 402-2 is text. The information stored in the storage unit 152 may be readable by certain external devices, such as the communication terminals 402-1 and 402-2.

The information stored in the storage unit 152 may be separately transmitted to the communication terminals 402-1 and 402-2 with a message using an SMS or an electronic mail.

In the following, a communication method for the communication system shown in FIG. 7 is described. FIG. 11 is a diagram for explaining an example of a procedure in the communication system shown in FIG. 7.

First, in step 21, the communication terminal 402-1 makes a call to the communication terminal 402-2. In step 22, the exchanger 202 notifies the management server 102 of the call. When the communication terminal 402-1 makes this call, the communication terminal 402-1 may perform, based on an external operation of the user, authentication of the user using the system such as inputting a PIN. In the management server 102,when the call detection unit 112 detects the call from the communication terminal 402-1 to the communication terminal 402-2, the information acquisition unit 122 acquires the essential information associated with the communication terminal 402-1 from the database 162. At this time, the information acquisition unit 122 acquires the name, the address, the electronic mail address, the personal identification information, the location information, and the like associated with the phone number of the communication terminal 402-1 from the database 162. In steps 23 and 24, the inquiry unit 132 transmits inquiry information to the communication terminal 402-1 through the exchanger 202 to inquire about an information transmission means to the communication terminal 402-2. This inquiry information is for inquiring which of a text communication or a voice communication is to be selected as the information transmission means to the communication terminal 402-2. Alternatively, this inquiry information may be for inquiring about whether to select transmitting only the essential information.

The communication terminal 402-1 outputs the inquiry information as a guidance. For example, the communication terminal 402-1 may display or output by voice a message “Press 1 to synthesize voice or press 2 to convert the message into text data”. Alternatively, the communication terminal 402-1 may, for example, display or output by voice a message “Input your PIN and press 1 to notify the contact person of the essential information”.

Then, in step 25, the communication terminal 402-1 transmits, to the management server 102 thorough the exchanger 202, the response information input based on the user's operation in response to the output inquiry information. In step 26, the management server 102 outputs an instruction to the exchanger 202 to receive the call from the communication terminal 402-1 to the communication terminal 402-2.

Then, the prediction unit 172 predicts prediction sentences based on the input information input and transmitted by the communication terminal 401-1 using the association stored in the database 162.

When the response information indicates a voice communication, the transmission unit 142 instructs the exchanger 202 to transmit the essential information, the input information input and transmitted by the communication terminal 402-1 thereafter, and the sentences predicted by the prediction unit 172 to the communication terminal 402-2 by voice obtained by voice synthesis or the like. On the other hand, when the response information indicates a text communication, the transmission unit 141 instructs the SMS/mail server 302 to transmit the essential information, the input information input and transmitted by the communication terminal 402-1 thereafter, and the sentences predicted by the prediction unit 172 to the communication terminal 402-2 by text data. At this time, the conversion from the voice data to the text data may be performed by the transmission unit 142.

The storage unit 152 stores the communication between the communication terminal 402-1 and the communication terminal 402-2.

Note that, the content that the communication terminal 402-1 has not sufficiently conveyed to the communication terminal 402-2 with the input information and the prediction sentence may be compensated with transmission and reception of text data thereafter (for example, display in a conversation style, such as a chat). For example, when input information and prediction sentence are “My stomach hurts. Call an ambulance right now.”, the input from the communication terminal 402-2 “OK. Since when has your stomach hurt?” and the input from the communication terminal 402-1 “Since three hours ago.” may be displayed in a chat style.

In the above example embodiment, a usage example in which a so-called smart phone is used as each of the communication terminals 402-1 and 402-2 is described. When the communication terminals 402-1 and 402-2 are so-called feature phones, the usage method is slightly different. However, a usage example of feature phones can be utilized by a device such as a smart phone.

When the communication terminal 402-1 that is a feature phone makes a call, the management server 102 detects the call and causes the communication terminal 402-2 to receive the call through the exchanger 202. After the communication terminal 402-2 receives the call, the management server 102 ends the call through the exchanger 202 when the communication terminal 402-1 receives an external operation (for example, a button operation or the like). Then, the management server 102 instructs the SMS/mail server 302 to transmit, to the communication terminal 402-1, an SMS/electronic mail or the like that can be processed by the communication terminal 402-1. This SMS/electronic mail or the like may include URL information for connecting a predetermined website. Then, when the communication terminal 402-1 transmits input information by designating the URL indicated by the URL information included in the SMS/electronic mail or the like transmitted from the SMS/mail server 302, the management server 102 and the SMS/mail server 302 transmit the prediction information on the basis of the input information together with the input information to the communication terminal 402-2.

Then, information input to the communication terminal 402-2 in response to the input information transmitted to the communication terminal 402-2 is transmitted to the communication terminal 402-1 through the management server 102 and the SMS/mail server 302.

By performing this processing, information transmitted and received between the communication terminal 402-1 and the communication terminal 402-2 is displayed, for example, in a conversation style, such as a chat.

The communication between the communication terminal 402-1 and the communication terminal 402-2 may be in a standby state without being disconnected until information is input to the communication terminal 402-1. In this case, a message indicating that the communication terminal 402-2 is in the standby state (for example, “Caller is inputting information. Please wait.” as a guidance) may be output by voice during the standby state.

Alternatively, at a timing when inputting information to the communication terminal 402-1, such as chat inputting as described above, is started, the start of inputting may be notified to the management server 102. In this case, the notified management server 102 may make a call from a predetermined phone number (for example, a calling-only number or the like) to the communication terminal 402-2, the communication terminal 402-1 may perform text inputting, and the communication terminal 402-2 may perform voice inputting.

In this manner, the management server 102 transmits the essential information about the source communication terminal and the input information to the destination communication terminal using the information transmission means desired by the source communication terminal. In addition, when input information transmitted from the source communication terminal is not sufficient, the management server 102 transmits sentences predicted from the input information to the destination communication terminal. Thus, it is possible to easily convey necessary information by a desired information transmission means. Specifically, it is possible to transmit information using various information transmission means, such as a call, an electronic mail, or a FAX, at any time and situation. Furthermore, by using the sentence prediction function, request information such as “What is needed” can be recognized at the call destination.

### Modification

The management server 102 may have a translation function. For example, when input information transmitted from the communication terminal 402-1 is in Japanese and the communication terminal 402-1 instructs the management server 102 to translate the input information into English, the management server 102 may translate the input information from Japanese into English using the translation function and transmit it to the communication terminal 402-2.

Further, a source communication terminal and a destination communication terminal may be inverted from the above description. That is, when a call from the communication terminal 402-1 shown in FIG. 7 to the communication terminal 402-2 is detected, but is disconnected, and the communication terminal 402-2 makes a call to the communication terminal 402-1, similar processing may be performed. Specifically, when the call detection unit 112 detects a call from the communication terminal 402-1 to the communication terminal 402-2, but the call is disconnected, and the call detection unit 112 detects a call from the communication terminal 402-2 to the communication terminal 402-1 thereafter, the information acquisition unit 122 may acquire the essential information associated with the communication terminal 402-1 from the database 162, and the inquiry unit 132 may transmit inquiry information to the communication terminal 402-2 to inquire about an information transmission means to the communication terminal 402-2. With this processing, even if a call from the communication terminal 402-1 to the communication terminal 402-2 is disconnected, the above effect can be obtained by performing similar processing if the communication terminal 402-2 makes a call. Furthermore, when a call from the communication terminal 402-1 to the communication terminal 402-2 is disconnected, and a communication terminal of a third person makes a call to the communication terminal 402-1 based on the call history, the management server 102 may transmit inquiry information to the communication terminal 402-1 and transmit the essential information to the communication terminal of the third person. At this time, the communication terminal 402-1 may permit to transmit the essential information to the communication terminal of the third person based on an external operation.

The present disclosure can be applied, when chat (conversation) inputting as described above is used, to a chat in which a third person joins the conversation and communication is performed by a group. For example, a communication terminal of a third person may join a conversation between the communication terminal 402-1 and the communication terminal 402-2, and the input information input to the communication terminal of the third person may be transmitted on the conversation using the information transmission means used for the conversation.

Here, the number of communication terminals of the third person may be plural.

Note that, a plurality of example embodiments has been described above, and the example embodiments may be combined.

In the above description, each constituent element has its function (processing), but this correspondence is not limited to the above. In addition, the configurations of the constituent elements in the above example embodiments are merely examples, and configurations are not limited thereto.

The processing performed by each constituent element included in each of the management servers 100 to 102 may be performed by a logical circuit manufactured for each purpose. In addition, a computer program (hereinafter, referred to as a program) describing processing content as a procedure may be stored in a storage medium readable by each of the management servers 100 to 102, and the program stored in the storage medium may be loaded and executed by each of the management servers 100 to 102. The storage medium readable by each of the management servers 100 to 102 includes a movable storage medium, such as a floppy (registered trademark) disc, a magneto-optical disc, a Digital Versatile Disc (DVD), a Compact Disc (CD), or a Blu-ray (registered trademark) Disc, a memory, such as a Read Only Memory (ROM) or a Random Access Memory (RAM) incorporated in each of the management servers 100 to 102, or a Hard Disc Drive (HDD). The program stored in the storage medium is loaded in a Central Processing Unit (CPU) provided in each of the management servers 100 to 102, and similar processing as described above is performed under the control of the CPU. Here, the CPU operates as a computer that executes the program loaded from the storage medium storing the program.

Some or all of the above example embodiments can be described as following Supplementary notes, but are not limited thereto.
(Supplementary note 1) A management server comprising:
a call detection unit configured to detect a call from a first communication terminal to a second communication terminal;
an information acquisition unit configured to acquire, when the call detection unit detects the call, essential information associated with the first communication terminal;
an inquiry unit configured to transmit, to the first communication terminal, inquiry information for inquiring about an information transmission means to the second communication terminal; and
a transmission unit configured to transmit the essential information to the second communication terminal using an information transmission means indicated by response information transmitted from the first communication terminal in response to the inquiry information.
(Supplementary note 2) The management server according to Supplementary note 1, wherein the inquiry unit transmits inquiry information for inquiring which of a text communication or a voice communication is to be selected as the information transmission means.
(Supplementary note 3) The management server according to Supplementary note 1 or 2, wherein the transmission unit transmits, to the second communication terminal, input information transmitted from the first communication terminal using the information transmission means.
(Supplementary note 4) The management server according to Supplementary note 3, further comprising a prediction unit configured to predict a sentence based on the input information transmitted from the first communication terminal,
wherein the transmission unit transmits the sentence predicted by the prediction unit to the second communication terminal.
(Supplementary note 5) The management server according to any one of Supplementary notes 1 to 4, further comprising a storage unit configured to store information transmitted to the second communication terminal.
(Supplementary note 6) The management server according to any one of Supplementary notes 1 to 5, wherein
the call detection unit detects a call from the second communication terminal to the first communication terminal, and
the inquiry unit transmits, to the second communication terminal, inquiry information for inquiring about an information transmission means to the second communication terminal.
(Supplementary note 7) The management server according to any one of Supplementary notes 1 to 6, further comprising a database configured to store the essential information,
wherein the information acquisition unit acquires the essential information associated with the first communication terminal from the database.
(Supplementary note 8) The management server according to any one of Supplementary notes 1 to 6, wherein the information acquisition unit acquires the essential information associated with the first communication terminal from a database provided outside the management server.
(Supplementary note 9) The management server according to any one of Supplementary notes 1 to 8, wherein the essential information is at least one of a name, an address, a phone number, an electronic mail address, personal identification information, and location information.
(Supplementary note 10) A communication method comprising:
detecting a call from a first communication terminal to a second communication terminal;
acquiring, when the call is detected, essential information associated with the first communication terminal;
transmitting, to the first communication terminal, inquiry information for inquiring about an information transmission means to the second communication terminal; and
transmitting the essential information to the second communication terminal using an information transmission means indicated by response information transmitted from the first communication terminal in response to the inquiry information.
(Supplementary note 11) A storage medium storing a program for causing a computer to execute:
a step of detecting a call from a first communication terminal to a second communication terminal;
a step of acquiring, when the call is detected, essential information associated with the first communication terminal;
a step of transmitting, to the first communication terminal, inquiry information for inquiring about an information transmission means to the second communication terminal; and
a step of transmitting the essential information to the second communication terminal using an information transmission means indicated by response information transmitted from the first communication terminal in response to the inquiry information.

The present disclosure has been described in detail with reference to the desirable example embodiments and examples, but is not limited to the example embodiments and examples, and various modifications and corrections can be made without departing from the gist of the disclosure.

This application is based upon and claims the benefit of priority of Japanese Patent Application No. 2017-050265 filed on Mar. 15, 2017, the disclosure of which is incorporated herein in its entirety by reference.

1. A management server comprising:
a call detection unit configured to detect a call from a first communication terminal to a second communication terminal;
an information acquisition unit configured to acquire, when the call detection unit detects the call, essential information associated with the first communication terminal;
an inquiry unit configured to transmit, to the first communication terminal, inquiry information for inquiring about an information transmission means to the second communication terminal; and
a transmission unit configured to transmit the essential information to the second communication terminal using an information transmission means indicated by response information transmitted from the first communication terminal in response to the inquiry information.

2. The management server according to claim 1, wherein the inquiry unit transmits inquiry information for inquiring which of a text communication or a voice communication is to be selected as the information transmission means.

3. The management server according to claim 1, wherein the transmission unit transmits, to the second communication terminal, input information transmitted from the first communication terminal using the information transmission means.

4. The management server according to claim 3, further comprising a prediction unit configured to predict a sentence based on the input information transmitted from the first communication terminal,
wherein the transmission unit transmits the sentence predicted by the prediction unit to the second communication terminal.

5. The management server according to any one of claim 1, further comprising a storage unit configured to store information transmitted to the second communication terminal.

6. The management server according to claim 1, wherein
the call detection unit detects a call from the second communication terminal to the first communication terminal, and
the inquiry unit transmits, to the second communication terminal, inquiry information for inquiring about an information transmission means to the second communication terminal.

7. The management server according to claim 1, further comprising a database configured to store the essential information,
wherein the information acquisition unit acquires the essential information associated with the first communication terminal from the database.

8. The management server according to claim 1, wherein the information acquisition acquires the essential information associated with the first communication terminal from a database provided outside the management server.

9. The management server according to claim 1, wherein the essential information is at least one of a name, an address, a phone number, an electronic mail address, personal identification information, and location information.

10. A communication method comprising:
detecting a call from a first communication terminal to a second communication terminal;
acquiring, when the call is detected, essential information associated with the first communication terminal;
transmitting, to the first communication terminal, inquiry information for inquiring about an information transmission means to the second communication terminal; and
transmitting the essential information to the second communication terminal using an information transmission means indicated by response information transmitted from the first communication terminal in response to the inquiry information.

11. A non-transitory computer readable medium storing a program for causing a computer to execute:
detecting a call from a first communication terminal to a second communication terminal;
acquiring, when the call is detected, essential information associated with the first communication terminal;
transmitting, to the first communication terminal, inquiry information for inquiring about an information transmission means to the second communication terminal; and
transmitting the essential information to the second communication terminal using an information transmission means indicated by response information transmitted from the first communication terminal in response to the inquiry information.
